(19) United States
(12) Patent Application Publication
(10) Pub. No.: US 2009/0065401 A1
(43) Pub. Date: Mar. 12, 2009

(54) ATMOSPHERIC FRACTIONATION FOR HYDROCRACKING PROCESS

(76) Inventors: John A. Petri, Palatine, IL (US); Vasant P. Thakkar, Des Plaines, IL (US)

Correspondence Address: HONEYWELL INTERNATIONAL INC;PATENT SERVICES, 101 COLUMBIA DRIVE, P O BOX 2245 MAIL STOP AB/2B, MORRISTOWN, NJ, 07962, US

(21) Appl. No.: 11/854,172

(22) Filed: Sep. 12, 2007

(51) Int. Cl. C10G 21/02; B01D 3/26

(52) U.S. Cl. 208/312; 202/158; 208/315

(57) ABSTRACT

In an atmospheric fractionator, the number of theoretical stages are increased in the upper light distillate flash zone and in the middle heavy distillate flash zone. The middle distillate pumparound circuit has been eliminated. The reflux to distillate ratio for the light distillate as well as the effluent feed temperature have been substantially increased. As a result, increased yields for middle distillate (e.g. kerosene) and heavy distillate (eg diesel) have been achieved which more than offset the increased energy consumption used for the higher feed temperature In the example of hydrocracking technology, the improved fractionation has benefits in the hydrocracking unit outside of the fractionation unit Increased fractionation efficiency reduces the severity in the hydrocracking unit reactor catalyst and less hydrogen is consumed. The invention can be applied to several other refining technologies besides hydrocracking.

### BACKGROUND

1. Technical Field

Improvements to the hydrocarbon conversion process referred to in the art as hydrocracking are shown and described Hydrocracking is used in petroleum refineries to reduce the average molecular weight of heavy or middle fractions of crude oil. Disclosed herein are improved atmospheric fractionation or distillation column designs and methods of use thereof that result in increased kerosene and diesel production through enhanced fractionation of a vaporized feed stream into naphtha, kerosene, diesel and unconverted oil (UCO) streams The disclosed process and apparatus are also applicable to visbreaking, fluidized catalytic cracking and delayed coking operations.

2. Description of the Related Art

Petroleum refiners often produce products such as “middle distillates” (jet fuel, kerosine, diesel, “No.2 distillate”) and naphtha and other products by “hydrocracking” a hydrocarbon feedstock derived from crude oil. Feedstocks most often subjected to hydrocracking are gas oils and heavy gas oils recovered from crude oil by distillation. A typical heavy gas oil comprises about 50% or more hydrocarbon components boiling above about 371° C. (700° F.). A typical vacuum gas oil normally has a boiling point range roughly between 315 and 565° C. (−600-˜1050° F.).

Hydrocracking is generally accomplished by contacting the feedstock with a hydrocracking catalyst in a hydrocracking reaction vessel or zone at elevated temperature and pressure in the presence of hydrogen which results in a product containing a distribution of hydrocarbon products desired by the refiner. The reactor operating conditions and the hydrocracking catalyst can be manipulated to influence the yield and composition of the hydrocracked products.

Although a wide variety of process flow schemes, operating conditions and catalysts have been used in various hydrocracking schemes, there is always a demand for new hydrocracking methods which provide lower overall costs, higher liquid product yields and the desired product streams For example, the market for diesel is anticipated to rise worldwide and therefore maximum quantities of diesel boiling range hydrocarbons is now preferred Further, in many countries, the demand for kerosene boiling range hydrocarbons is quite high as it is used for cooking and heating. Consequently, maximum quantities of both diesel and kerosene from hydrocracking processes are being demanded by many refiners

As hydrocracking techniques are modified to yield more middle distillate materials, fractional distillation or fractionation techniques will need to be modified to harvest a greater yield of the desired components. Thus, there is a need for improved fractionation techniques and equipment which increase the fractionation efficiency between the naphtha and kerosene cut and which increases the fractionation efficiency between the diesel and unconverted oil/recycle oil cut to improve kerosene and diesel yields.

Still further, there is a need for improved fractionation technique which improves the separation between the naphtha and kerosene in one zone of the fractionation column and between a diesel draw and the unconverted oil and/or any recycled unconverted oil in another zone of the fractionation column.

### SUMMARY OF THE DISCLOSURE

In accordance with the aforenoted needs, and in connection with hydrocracking, an improved technique for increasing kerosene and diesel (“distillate”) yields from a hydrocracking effluent is disclosed. The hydrocracker net reactor effluent may go through several stages of separation to afford a stabilized net effluent comprised substantially of naphtha and heavier boiling products. The improved method comprises injecting the stabilized reactor effluent into a fractionation column. The column comprises of a top, a bottom and a plurality of zones disposed between the top and the bottom The zones include a first zone disposed between the top and a second zone The second zone is disposed between the first zone and a third zone The third zone is disposed between the second zone and at least one lower zone. In an embodiment, a total of five zones are present overall.

The disclosed method includes drawing naphtha distillate from the top of the vessel through a naphtha vapor outlet line and condensing at least part of the naphtha distillate in a condenser. The method further includes returning at least part of the condensed naphtha distillate as naphtha reflux to the top or first zone of the column through a naphtha reflux line

In a refinement, the reflux to distillate ratio (R/D) for the naphtha reflux to the naphtha distillate drawn from the top of the vessel is greater than 3. Preferably, the R/D ratio ranges greater than 3 to about 5.5.

The method further comprises drawing kerosene from the second zone through a kerosene draw line that is connected to a kerosene stripper. The kerosene stripper is connected to a kerosene vapor return line and the method further comprises directing at least some of the kerosene that is vaporized in the kerosene stripper back to the second zone through a kerosene vapor return line

The method further comprises drawing diesel from the third zone through a diesel stripper draw line that is connected to diesel stripper. The diesel stripper is also connected to a diesel vapor return line and the method comprises passing at least some diesel that is vaporized in the diesel stripper back to the third zone through the diesel vapor return line.

The method also comprises drawing increased diesel yields from the diesel stripper and drawing increased kerosene yields from the kerosene stripper This is accomplished by an increased number of theoretical stages in the first and third zones. Broadly, at least one of the first or third zones includes from 15 to about 20 theoretical stages (NTS) This is in contrast to conventional systems with an NTS of about seven (7) in the first zone and about eight (8) in the third zone. Through increased both kerosene and diesel yields, the NTS in both the first and third zones will each range from 15 to about 20 in each zone.

Increased kerosene and diesel yields are also obtained by increasing the feed temperature. Specifically, the feed temperature for a hydrocracking effluent feed stream is increased from the conventional 371° C. (700° F.) to a range of about 375 to about 390° C. (˜707-˜734° F.), preferably about 385° C.

The above technique may eliminates the need for a kerosene pumparound circuit A typical fractionation design will remove heat by preheating water for steam generation or reject the heat in this pumparound to the atmosphere. While possibly performing some useful heat integration, the heat removal in the kerosene pumparound may detract from providing increased liquid to vapor contacting in the zone that could better separate the naphtha and kerosene. Accordingly, removal of the kerosene pumparound circuit is preferred to take advantage of the increased NTS in the embodiment of this invention. Thus, in a preferred embodiment, materi or enters the second zone through the top, the bottom, the draw line connected to the kerosene stripper or the return line from the kerosene stripper.

The above method may also be applied to visbreaking, fluidized catalytic cracking (FCC) and delayed coking operations. In one example, the yield of distillate in an FCC unit can be increased by recovering more distillate as a light cycle oil from the heavier draws that are lower in the FCC fractionation column The embodiment of this invention can also be used in the opposite way. For example, the increased separation between naphtha and kerosene can be used to improve recovery of gasoline boiling range hydrocarbons (naphtha) from the front-end of the light cycle oil (distillate) Light cycle oil is the next heavier cut produced in the fractionation column in an FCC unit below the cracked gasoline draw. Accordingly, a light distillate is drawn off the top of the column.

The increase in number of theoretical stages of the first and third zones may be achieved by increasing the number of trays or using packing of either a structured or random type. In an embodiment, trays are replaced with packing having a height equivalent theoretical plate (HETP) substantially less than the 61 cm to 132 cm (24-48 in) provided by currently available distillation trays that are typically used in the industry. Typical HETP for packing is 46 to 61 cm (18 to 24 in) By utilizing packing, the number of theoretical stages in the first and third zones of the column may be doubled from the currently available 7 or 8 NTS to a range of 15-20 NTS In another embodiment, proprietary multi-downcomer trays can be used instead of more traditional distillation trays. Multi-downcomer trays may be spaced 12-18 in (30.4-45.7 cm), much closer than mote traditional distillation trays. In this way, the NTS can also be increased to 15 to 20.

Removing the kerosene or second zone pumparound enables the reflux to distillate ratio for the light distillate (the top draw in a fractionation column) or naphtha to be substantially increased In one example relating to hydrocracking technology, by eliminating kerosene pump around in the second zone and increasing the NTS to 15 to 20, kerosene or middle distillate yields have been increased about 1.5 wt %. The TBP cut point between naphtha and kerosene is the front-end cut point (FECP) for distillate production. In connection with hydrocracking, the improved commercial fractionation efficiency between naphtha and kerosene allows a lower true boiling point (TBP) cut point for a constant kerosene or distillate flash point In this way, more middle distillate of kerosene range material from the back end of the naphtha distillation can be recovered.

Turning to the heavy distillate or diesel recovery, the NTS is increased from approximately 16 real trays (8 NTS) to 15-20 NTS stages. Because the liquid/vapor (L/V) ratio can be poor in this zone of the fractionator, thus the liquid to vapor contact can be poor in this middle zone, packing is one preferred method to increase the NTS because the packing provides mote intimate contacting between liquid and vapor than a traditional tray. Accordingly, packing with a HETP of less than 61 cm (24 in) can be utilized Alternatively, additional traditional trays or, preferably proprietary multi-downcomer trays with lower HETP than traditional trays may be used. In any event, from 15 to 20 NTS is preferred for this third or middle zone that includes the diesel pump around circuit and the diesel draw/diesel stripper/diesel vapor return circuit. This improved third zone is disposed immediately above the feed flash zone. The bottom of the packing in the middle zone will also provide adequate surface area for the de-entrainment of fine droplets of unconverted oil (UCO) or heavy bottoms liquid. As the heavy distillate or diesel pumparound is included in this zone, adequate hot diesel or heavy distillate liquid is available to “wash” UCO off the bottom towards the bottom zone of the column.

The feed stream passes through a heater prior to entering the fourth zone which is the feed flash zone. The feed temperature is increased in accordance with this disclosure to take advantage of the enhanced separation between heavy diesel draw and the unconverted/recycled oil or, in other systems, between the heavy distillate and the bottoms liquid. By increasing the heater outlet temperature, the back-end cut point (BECP) is increased while maintaining compliance with the ASTM D-86 maximum T90% distillation specifications. Specifically, the separation efficiency can be indicated by ASTM D-86 distillation gap between the heavy diesel and unconverted oil. The gap is the heavy distillate ASIM D-86 T95% point minus the unconverted oil/recycled oil ASTM D-86 T5% point. By way of example, the separation efficiency as measured by the temperature gap is increased from 67° C. (20° F.) in the conventional design to 16.7° C. (50° F.) by implementing the disclosed techniques. The BECP can be increased 14 to 15° C. (5° F.). The increased BECP lowers reactor severity, increases distillate yields, and reduces hydrogen consumption. In one example, distillate yield as heavy diesel can be increased about 2.5 wt %.

The improved separation in the flash zone decreases entrainment of unconverted oil into the distillate. Specifically, the disclosed techniques result in improved distillate cold flow properties which allows for an increased BECP in the event cold flow properties are limiting the BECP

In accordance with this disclosure, in the example for hydrocracking technology, the overall distillate yields can be increased by 4 wt %, given the increases in the kerosene and diesel yields combined

To achieve the above results, an improved fractionation unit is disclosed are with one or more of the following features: pumparound circuit for heavy distillate only and not the medium distillates; and an increased number of theoretical stages in the first and/or third zones; increased light distillate R/D ratio; and a higher feed temperature.

While the disclosed embodiment is directed toward a hydrocracking process and more specifically and improved fractionation method and apparatus for a hydrocracking process, this disclosure is also applicable to visbreaking, fluid catalytic cracking and delayed coking processes. Therefore, in the disclosed embodiment, naphtha is considered to be the light distillate. However, other light distillates are possible and are considered within the scope of the present disclosure. Kerosene is considered to be the middle distillate in this disclosure but other middle distillates are possible. Similarly, diesel is considered to be the heavy distillate but other heavy distillates are possible.

Other advantages and features will be apparent from the following detailed description when read in conjunction with the attached drawings.

### BRIEF DESCRIPTION OF THE DRAWING

For a more complete understanding of the disclosed methods and apparatuses, reference should be made to the embodiment illustrated in greater detail on the accompanying drawings, wherein:

FIG. 1 is a schematic flow diagram illustrating one disclosed process and apparatus.

In certain instances, details which are not necessary for an understanding of the disclosed methods and apparatuses or which render other details difficult to perceive may have been omitted. It should be understood, of course, that this disclosure is not limited to the particular embodiments illustrated herein.

### DETAILED DESCRIPTION OF THE PRESENTLY PREFERRED EMBODIMENTS

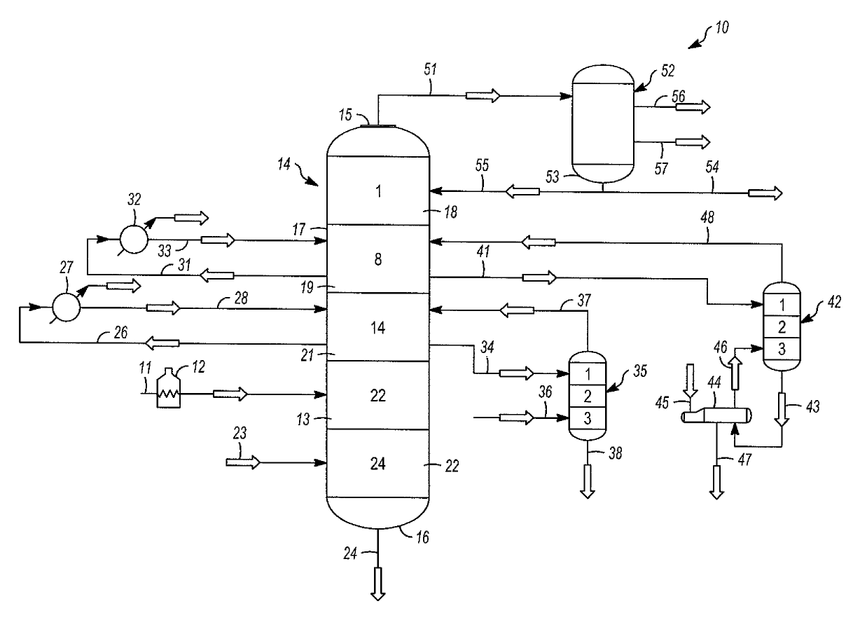

A disclosed atmospheric fractionator system 10 is shown in FIG 1. Feed is introduced through the line 11 and is heated in a heating apparatus 12 before being introduced into the flash zone 13 of the fractionation column 14. The column 14 includes a top 15, a bottom 16 and a generally cylindrical uptight section 17. The column 14 can be divided into five zones with a top or first zone shown at 18, a second or kerosene flash zone shown at 19, a third middle or diesel feed flash zone shown at 21, a fourth or feed/zone 13 and a bottom or fifth zone 22. The feed passing through the line 11 is typically a hydrocracking effluent stream and is heated by the heating element 12 to a temperature of about 371° C. (700° F.). A portion of the feed flashes or vaporizes and migrates upward and the heavier components of the feed migrate downward towards the bottom zone 22. Bottoms stripping steam may be injected into the bottom zone 22 through the line 23. The heaviest material, UCO and/or unconverted recycle oil, exits the bottom 16 of the vessel 14 through the bottoms outlet 24.

Heavy distillate and lighter boiling material migrates upward from the zone 13 to the zone 14 In this example, heavy distillate comprises hydrocarbon compounds in the diesel boiling range In the diesel pumparound circuit, diesel liquid is drawn from the zone 21 through the line 26 and passed through the diesel cooler 27, where cooled liquid is returned to the column 14 through the line 28 and to the zone 21 Similarly, hydrocarbons boiling in the kerosene and lighter range migrate upward through the column 14 to the zone 19.

In prior art systems, a kerosene pumparound circuit is included where kerosene liquid is drawn out of the column 14 at the second zone the 17 through the line (not shown) and passed to the kerosene cooler before being returned as cooled liquid to the column 14 through a return line 33, also not shown. As explained below, the disclosed system and method eliminates the need for a kerosene pump around circuit.

Diesel or heavy distillate and kerosene or middle distillate materials are withdrawn from the column 14 as product in a similar fashion. Specifically, diesel is drawn from the third or middle zone 21 through the line 34 where it enters the upper zone of a diesel stripper column 35. Steam is injected into the diesel stripper 35 through the line 36. Vaporized materials with a lower boiling point than diesel materials pass out of the stripper 35 through the line 37 where they are returned to the zone 21 as vapor. Diesel product is withdrawn from the stripper 35 through the line 38.

Similarly, kerosene-weight hydrocarbons are drawn from the line 41 and injected into a kerosene stripper 42. The bottoms liquid from the kerosene stripper 42 is removed from the stripper 42 through the line 43 before it is delivered to a reboiler 44. Steam may be injected into the stripper 42 but, typically, steam is injected into the reboiler 44 through the line 45 and lighter weight materials are returned to the kerosene stripper 42 through the line 46. Kerosene product is withdrawn from of the system through the line 47. Lighter weight material returned to the zone 19 of the column 14 through the line 48 as vapor.

Light distillate material, such as naphtha, is removed from the top 15 of the column 14 through the line 51 where it is delivered through the condenser/receiver shown at 52. Naphtha product is drawn out the bottom 53 of the condenser through the line 54 while a portion of the naphtha product is returned to the zone 18 of the column 14 through the line 55 as reflux. Heat is removed from the condenser by conventional means at 56 and liquid water is removed through the line shown at 57 It will be noted that a separate receiver vessel is not shown in FIG. 1.

In conventional systems, the reflux to distillate (R/D) ratio, represented by the flow rate through the line 55 divided by flow rate through the line 51, ranges from about 0.5 to 3. The NTS in the zone 18 is typically seven (7) in the zone 19 in FIG. 1 (counted from the top 15, including the condenser/receiver 52) The NTS in the second zone 19 is typically six (6) in the zone 21. Further, the number of theoretical stages in the zone 21 is also typically eight (8). Thus, in a conventional system, the total NTS in such a prior art atmospheric fractionator for a hydrocracking process is approximately 24. In contrast, as shown in FIG. 1, the total number of theoretical stages has been increased to from about 38 to about 48.

Effluent feed is delivered to the column 14 through the line 11 that is linked to the heater 12. The feed flash zone is shown at 13. Feed is delivered to the zone 13 at a higher temperature, ranging from about 375° C. to about 390° C. (˜707-˜734° F.), preferably about 385° C. (725° F.) The outlet temperature from the heater 12 is increased to take advantage of the enhanced separation between heavy diesel draw and unconverted oil/recycled oil. By increasing the heater outlet temperature, the bottoms end cut point (BECP) is increased while maintaining the limiting distillate specification, an ASTM D-86 T90% distillation point or a similarly, a requited cold flow property Surprisingly, the inventors have found that the BECP cannot be increased without increasing separation efficiency between the diesel or heavy distillate and the unconverted oil or bottoms liquid. As provided herein, the gap between the heavy diesel and unconverted oil is the heavy diesel ASTM D-86 T95% point minus the unconverted oil ASIM D-86 T5% point. The BECP is increased about 14° C. (about 25° F.)

In addition to an increased feed temperature, additional theoretical stages are added to the zone 18. Preferably, the number of stages is increased in zone 18 from seven (7) or eight (8) to a range of 15-20. This can be accomplished with additional trays or, more preferably, packing. Packing may be either a random or ordered type. The number of stages in the second zone or kerosene flash zone 19 does not need to be modified. However, the kerosene pumparound circuit has been eliminated which enables the R/D ratio to be increased to greater than the conventional upper limit of 3.

Specifically, the R/D ratio for the lines 55 and 51 has been dramatically increased from the range of 0.5 to 3 to greater than 3 and preferably in the range from greater than 3 to 5 or more.

In the disclosed embodiment, by at least doubling the number of theoretical stages in the zone 19, either by adding additional trays or using structured or random packing and removing the kerosene pumparound circuit, which consequently increases the R/D ratio, tests have indicated that the design shown in FIG. 1 increases kerosene yield about 1.5 wt % for the aforementioned hydrocracking example The improved commercial fractionation efficiency between naphtha and kerosene allows a lower true boiling point (TBP) cut point for a constant flash point. This TBP cut point is the front end cut point (FECP) for distillate production In this way, more kerosene material from the back end of the naphtha distillation can be recovered as distillate through the line 47. As noted above, increased kerosene yields are desirable. As also previously noted, the invention can be applied in the opposite to increase naphtha yields if naphtha is more desirable than kerosene.

Turning to the middle or diesel flash zone 21, the NTS has also been dramatically increased from the conventional six (6) or seven (7) to a range of 15-20. This can be achieved again by increasing tray count or using structured or random packing. In conventional systems, the liquid/vapor (L/V) ratio can be poor (0 05-0 25) leading to poor separation efficiency as indicated by the ASTM D-86 distillation gap. In a preferred embodiment, this obstacle is overcome by using packing or proprietary multi-downcomer trays. The bottom of the packing in the zone 21 also provides a surface area for the de-entrainment of any fine droplets of unconverted oil. Hot diesel is pumped down from the diesel pumpaiound circuit 26, 27, 28 to the top of zone 13 which provides suitable liquid for the separation and also washing of this unconverted oil.

In has been found that the improved separation between heavy diesel and unconverted oil, along with the increased BECP results in diesel yields being increased about 2.5 wt % Thus, the improved separation between diesel and unconverted oil in the flash zone 13 decreases entrainment of unconverted oil into the heavy distillate and provides improved distillate cold flow properties thereby permitting the increased BECP. The design of FIG. 1, with any one or more of the disclosed design features including the increased feed temperature, increased theoretical stages in the upper zone 18 and middle zone 21, the increased R/D ratio and the elimination of the kerosene pumparound circuit, can be exploited to increase kerosene and diesel yields collectively about 4 wt % in the aforementioned hydroctacking example Thus, a significant advantage over conventional systems is provided

Finally, a disengaging device may be added to the flash zone 13. Free space may also be provided and/or increased between such a disengaging device and the bottom of the packing or lower most tray in the middle zone 21. The zone of free space is intended to provide residence time for the disengagement of the more course droplets of unconverted oil.

Data in support of the claimed improvements to the front and of the column 14 is provided in Table 1. Referring to Example A, removing the kerosene pumparound circuit, and increasing the R/D ratio to 4.49 increases the kerosene yield about 0.85 wt %. Referring to Example B, removing the kerosene pumparound circuit in combination with adding seven (7) theoretical stages to zone 18 and increasing the R/D ratio to 5.08 increases the kerosene yield about 1 53 wt %. Referring to Example C, adding 14 theoretical stages total to zone 18, increasing the R/D ratio to 5.12 and eliminating the kerosene pumparound circuit increases the kerosene yield about 1.66 wt % total These advances are significant in the competitive oil refining or hydrocracking market

TABLE 1

| | Prior Art | Example A | Example B | Example C |
|---|---|---|---|---|
| Action | None | Remove | Remove | Remove |
| | | kerosene | kerosene | kerosene |
| | | pumparound | pumparound, | pumparound, |
| | | (PA) | add 7 theoretical | add 7 theoretical |
| | | | naphtha/ | naphtha/ |
| | | | kerosene section | kerosene section |
| | | | trays (zone 18), | trays(zone 18), |
| | | | increase R/D | increase R/D |
| Naphtha (kg/h) | 129600 | 123200 | 118100 | 117100 |
| Kerosene (kg/h) | 157100 | 163500 | 168600 | 169600 |
| Diesel (kg/h) | 415600 | 415600 | 415600 | 415600 |
| N/K Theoretical | 8 | 18 | 15 | 22 |
| Trays (Zone 18) | | | | |
| R/D (vol/vol) | 3.00 | 4.49 | 5.08 | 5.12 |
| N/K Gap (° C.) | 14.8 | 15.2 | 20.9 | 25.4 |
| N/K TBP Cut | 143.0 | 140.8 | 139.1 | 138.8 |
| Point (° C.) | | | | |
| Kero D-86 T5% | 156.0 | 156.0 | 156.0 | 156.0 |
| Point (° C.) | | | | |
| Kero PA (m3/h) | 593 | 0 | 0 | 0 |
| Δ Kero Yield | 0.0 | 0.85 | 1.53 | 1.66 |
| (wt %) | | | | |

The effect of increasing the number of increasing the number of theoretical stages in the diesel flash zone 21 is illustiated in Table 2.

TABLE 2

| | Prior | | |
|---|---|---|---|
| | Art | Example E | Example F |
| Action | None | Add 8 theoretical | Recycle slop wax, |
| | | stages in D/F zone | add 8 theoretical |
| | | 21, increase feed | stages in D/F zone |
| | | temp | 21, increase feed |
| | | | temp |
| D/FZ Theoretical | 8 | 16 | 16 |
| Stages | | | |
| D/UCO Gas (° C.) | 13 | 30 | 33 |
| D/UCO TBP Cut | 381.6 | 396.1 | 397.1 |
| Point (° C.) | | | |
| Diesel D-86 T95% | 354.6 | 634.6 | 354.6 |
| (° C.) | | | |
| Heater Outlet T (° C.) | 371 | 385 | 385 |
| Heater Stream Duty | 60.0 | 74.4 | 80.4 |
| (MMkcal/h) | | | |
| Δ Kero Yield (wt %) | 0.0 | 2.0 | 2.5 |

As seen in Examples E and F, adding eight theoretical stages to zone 21 in combination with increasing the feed temperature to 385° C. can increase the diesel yield by 2 wt % or more

Accordingly, the disclosed apparatus and method provides and effective means for increasing middle and heavy distillate yields through enhanced fractionation. In the disclosed embodiment, increased distillate yields of middle and heavy distillates from reactor effluent produced in hydrocracking reactors is provided. While specific increases in fractionation efficiency between naphtha and kerosene between diesel and unconverted oil are disclosed, it will be noted that these techniques and apparatus also apply visbreaking, fluidized catalytic cracking and delayed coking operations.

While only certain embodiments have been set forth, alternatives and modifications will be apparent from the above description to those skilled in the art. These and other alternatives are considered equivalents and within the spirit and scope of this disclosure and the appended claims

1. A method for increasing kerosene and diesel distillate yields from a stabilized hydrocracking reactor effluent stream, the method comprising:
injecting the reactor effluent into a column comprising
a top, a bottom, a plurality of zones disposed between the top and the bottom including a first zone disposed between the top and a second zone, the second zone disposed between the first zone and a third zone, the third zone disposed between the second zone and at least one lower zone,
drawing a naphtha distillate from the top of the column through a naphtha vapor outlet line, condensing at least part of the naphtha distillate in a condenser, and returning at least part of the condensed naphtha distillate as naphtha reflux to the first zone through a naphtha reflux line,
drawing kerosene from the second zone through a kerosene draw line that is connected to a kerosene stripper which is also connected to a kerosene vapor return line and passing at least some kerosene that is vaporized in the kerosene stripper from the kerosene stripper back to the second zone through the kerosene vapor return line,
drawing diesel from the third zone through a diesel stripper draw line that is connected to a diesel stripper which is also connected to a diesel vapor return line and passing at least some diesel that is vaporized in the diesel stripper back to the third zone through the diesel vapor return line,
drawing diesel from the diesel stripper,
drawing kerosene from the kerosene stripper;
at least one of the first and third zones having from 15 to about 20 theoretical stages.

2. The method of claim 1, further comprising
heating the reactor effluent stream to a temperature greater than 371° C. and injecting the effluent stream into a fourth zone disposed between the third zone and a bottom fifth zone.

3. The method of claim 1, further comprising
heating the reactor effluent stream to a temperature ranging from about 380° C. to about 390° C. and injecting the effluent stream into a fourth zone disposed between the third zone and a bottom fifth zone.

4. The method of claim 1, further comprising
heating the reactor effluent stream to a temperature of about 385° C. and injecting the effluent stream into a fourth zone disposed between the third zone and a bottom fifth zone.

5. The method of claim 1, wherein both the first and third zones include from 15 to about 20 theoretical stages.

6. The method of claim 1 wherein a ratio of naphtha reflux returned to the first zone to naphtha distillate drawn from the top is greater than 3.

7. The method of claim 1 wherein a ratio of naphtha reflux returned to the first zone to naphtha distillate drawn from the top ranges from greater than 3 to about 5.5.

8. The method of claim 1, further comprising
drawing diesel from the third zone through a diesel pump around draw line that is connected to a pump which is also connected to a diesel pump around return line that is connected to the third zone and returning the diesel in the diesel pump around draw line back to the third zone.

9. The method of claim 1, wherein kerosene is not drawn from the second zone and returned to the second zone in a pump around circuit without passing the kerosene through the kerosene stripper.

10. A method for improving middle distillate and heavy distillate yields in a fractionation between a light distillate, the middle and heavy distillates and a bottoms effluent, the method comprising:
injecting a feed into a column comprising
a top, a bottom, a plurality of zones disposed between the top and the bottom including a first zone disposed between the top and a second zone, the second zone disposed between the first zone and a third zone, the third zone disposed between the second zone and at least one other bottom zone,
drawing light distillate from the top through a light distillate vapor outlet line, condensing at least part of the light distillate in a condenser, and returning at least part of the condensed light distillate as light distillate reflux to the first zone through a light distillate reflux line,
drawing middle distillate from the second zone through a middle distillate draw line that is connected to a middle distillate stripper which is also connected to a middle distillate vapor return line and passing at least some middle distillate that is vaporized in the middle distillate stripper from the middle distillate stripper back to the second zone through the middle distillate vapor return line,
drawing heavy distillate from the third zone through a heavy distillate stripper draw line that is connected to a heavy distillate stripper which is also connected to a heavy distillate vapor return line and passing at least some heavy distillate that is vaporized in the heavy distillate stripper from the heavy distillate stripper back to the third zone through the heavy distillate vapor return line,
drawing heavy distillate from the heavy distillate stripper,
drawing middle distillate from the middle distillate stripper,
at least one of the first and third zones having from 15 to about 20 theoretical stages (NIP).

11. The method of claim 10, wherein both the first and third zones include from 15 to about 20 theoretical stages.

12. The method of claim 10 wherein a ratio of light distillate reflux returned to the first zone to light distillate drawn from the top is greater than 3.

13. The method of claim 10 wherein a ratio of light distillate reflux returned to the first zone to light distillate drawn from the top ranges from greater than 3 to about 5.5.

14. The method of claim 10, further comprising
drawing heavy distillate from the third zone through a heavy distillate pump around draw line that is connected to a pump which is also connected to a heavy distillate pump around return line that is connected to the third zone and returning the heavy distillate in the heavy distillate pump around draw line back to the third zone.

15. The method of claim 10, wherein middle distillate is not drawn from the second zone and returned to the vessel in a pump around circuit without first passing through the middle distillate stripper.

16. A fractionation unit comprising:
a fractionation column comprising a top, a bottom and a cylindrical wall extending therebetween,
the cylindrical wall housing five zones disposed between the top and the bottom including a first zone disposed between the top and a second zone, the second zone disposed between the first zone and a third zone, the third zone disposed between the second zone and a fourth zone, the fourth zone disposed between the third zone and a fifth zone, the fifth zone disposed between the fourth zone and the bottom,
the top comprising a vapor draw line connected to a condenser, the condenser connected to a reflux line that connects the condenser to the first zone,
the second zone connected to a light distillate cut line that is connected to a first distillate stripper, the light distillate stripper also connected to a light distillate reflux line that is connected to the second zone, material flowing to or from the second zone only through the top of the second zone, through the bottom of the second zone, to the first distillate stripper or from the first distillate stripper,
the third zone connected to a heavy distillate cut line that is connected to a heavy distillate stripper that connects the heavy distillate cut line to a heavy distillate reflux line, the heavy distillate reflux line connected to the third zone,
the fourth zone connected to a feed line, the feed line passing through a heater upstream of the vessel,
the first zone comprising from 15 to about 20 theoretical stages,
the third zone comprising from about 15 to about 20 theoretical stages.

17. The fractionation unit of claim 16 wherein the third zone is connected to a heavy distillate draw line that is connected to a heavy distillate pump that connects the heavy distillate draw line to a heavy distillate return line, the heavy distillate return line is connected to the third zone.

18. The fractionation unit of claim 16 wherein the second zone is not connected to a light distillate pump around circuit independent of the light distillate stripper.

19. The fractionation unit of claim 16 wherein the column is configured so that a ratio of light distillate reflux returned to the first zone to light distillate drawn from the top is greater than or equal to 3.

20. The fractionation unit of claim 16 wherein the column is configured so that a ratio of light distillate reflux returned to the first zone to light distillate drawn from the top ranges from greater than 3 to about 5.
